(19) United States
(12) Patent Application Publication
(10) Pub. No.: US 2021/0049396 A1
(43) Pub. Date: Feb. 18, 2021

(54) OPTICAL QUALITY CONTROL

(71) Applicant: Bayer Aktiengesellschaft, Leverkusen (DE)

(72) Inventor: Jochen RADMER, Berlin (DE)

(73) Assignee: Bayer Aktiengesellschaft, Leverkusen (DE)

(21) Appl. No.: 16/989,677

(22) Filed: Aug. 10, 2020

(30) Foreign Application Priority Data
Aug. 13, 2019 (EP) 19191387.0

(51) Int. Cl. G06K 9/32; G06T 7/00

(52) U.S. Cl. CPC G06K 9/3241; G06T 2207/20084; G06T 2207/20081; G06T 7/0004

(57) ABSTRACT

A method, a device, a system and a computer program product for creating a training and/or validation dataset for a self-learning algorithm for classifying objects using supervised learning.

### CROSS REFERENCE TO RELATED APPLICATIONS

This application claims priority benefit to European Application No. 19191387.0, filed Aug. 13, 2019, the disclosure of which is herein incorporated by reference in its entirety.

### FIELD OF THE DISCLOSURE

The present invention deals with the optical quality control of objects.

### BACKGROUND OF THE DISCLOSURE

Quality controls play an important role in many areas of industry. Quality control checks whether an object, such as a product or a raw material, meets predefined quality criteria. The predefined quality criteria (defined criteria) represent the target state. In quality control at least one feature of the particular object is checked. The at least one feature indicates the actual state of the object. In a further step, the actual state is compared with the target state. The target state is usually defined by one or more parameter ranges for the at least one feature. If the actual parameter for the at least one feature is within this range or if the multiple actual parameters are within these ranges, the object meets the quality criteria. Otherwise, it does not meet the corresponding quality criteria. For a product, failure to meet the quality criteria may mean that it cannot be placed on the market. For a raw material, failure to meet the quality criteria may mean that the raw material should not be used. The goal of a quality control can therefore be to reject objects that do not meet a defined specification.

In optical quality control the at least one feature of an object that is tested is related to the object's interaction with electromagnetic radiation, preferably in the visible wavelength range (approximately 380 nm to 780 nm). Examples of such optical features are spatial and/or temporal characteristics of color, texture, absorption capacity, reflectivity and the like. Optical quality control is usually carried out in a non-contact manner by irradiating the object with an electromagnetic radiation source and capturing the radiation reflected by the object and/or passing through the object with a sensor and then analyzing the sensor signal.

Often, the sensors used in optical quality control are cameras that capture two-dimensional images of light by electrical means. Typically, these are semiconductor-based image sensors such as CCD charge-coupled device) or CMOS (complementary metal-oxide-semiconductor) sensors. Such cameras can be used to create digital images of the objects.

In many areas, optical quality control is performed semi-automatically. In a first, automatic step, an optical feature of an object to be tested is determined and this is compared against a defined criterion. Those objects for which the optical feature does not meet the defined criterion are screened out and visually re-inspected by trained personnel in a second, non-automated step. This type of post-inspection is often necessary because the automatic system is typically configured such that it tends to screen out too many objects rather than too few objects. However, in order to minimize the number of objects rejected, the automatically screened out objects are visually re-inspected by a human being. Such a procedure can be made the objective of a validated process for optical quality control according to GMP (Good Manufacturing Practice). Those objects that have been rejected by the automated first step, but which according to the human inspector's judgement should not have been rejected, can be fed back again.

As in many industrial fields, systems based on artificial intelligence are also increasingly being used in the field of optical quality control. These include so-called self-learning systems, which can be trained, for example by means of supervised learning, to classify objects on the basis of optical features.

### SUMMARY OF THE DISCLOSURE

The objects of the present invention, according to some embodiments, include a method, a device, a system and a computer program product for creating a training and/or validation dataset for a self-learning algorithm for classifying objects using supervised learning.

According to some embodiments, a method comprises:

classifying objects into at least two classes, a first class and a second class, wherein the first class contains those objects that meet at least one defined criterion and the second class contains those objects that are to be subjected to a visual inspection, create digitally recorded images of the objects labelling the recorded images of the objects assigned to the first class with a first identifier, the first identifier indicating that the objects on the recorded images meet the at least one defined criterion, supplying the recorded images of the objects assigned to the second class to a visual inspection stage, receiving a result of the visual inspection for objects of the second class, said result indicating whether the respective object meets the at least one defined criterion or does not meet the at least one defined criterion, labelling the recorded images of the objects assigned to the second class with an identifier, wherein the recorded images of those objects for which the result indicates that the object meets the at least one defined criterion are labelled with the first identifier, and the recorded images of those objects for which the result indicates that the object does not meet the at least one defined criterion are labelled with a second identifier, storing the labelled images in a data memory and/or training and/or validating a self-learning model to classify objects with the labelled images.

According to some embodiments, a device comprises:

a receiving unit,

a control and calculation unit and

an output unit,

wherein the control and calculation unit is configured to cause the receiving unit to receive digital recorded images, wherein each digital recorded image shows an object, the object shown being assigned to one of at least two classes, a first class containing objects that meet at least one defined criterion, and a second class containing objects that are to undergo a visual inspection,

wherein the control and calculation unit is configured to label the digitally recorded images of the objects of the first class with a first identifier, the first identifier indicating that the objects on the recorded images meet the at least one defined criterion,

wherein the control and calculation unit is configured to cause the output device to display the recorded images of the objects of the second class to a user,

wherein the control and calculation unit is configured to cause the receiving unit to receive information from the user relating to displayed recorded images, the information indicating whether the respective object meets the at least one defined criterion or does not meet the at least one defined criterion,

wherein the control and calculation unit is configured, based on the information received, to label the respectively displayed recorded image with a first identifier, wherein the recorded image of the object for which the information indicates that the object meets the at least one defined criterion is labelled with the first identifier, and the recorded image of the object for which the information indicates that the object does not meets the at least one defined criterion is labelled with a second identifier,

wherein the control and calculation unit is configured to cause the output unit to store the labelled images in a data memory and/or to supply them to a self-learning object classification model as a training and/or validation dataset.

Another object of the present invention, according to some embodiments, is a system comprising a camera for creating digital images of objects, and a device according to embodiments of the invention.

A further object of the present invention, according to some embodiments, is a computer program product comprising a computer program that can be loaded into a working memory of a computer where it causes the computer to implement the following:

receiving digital recorded images, wherein each digital recorded image shows an object, wherein the object shown is assigned to one of at least two classes, a first class containing objects that meet at least one defined criterion, and a second class containing objects that are to undergo a visual inspection,
labelling the digital recorded images of the objects assigned to the first class with a first identifier, the first identifier indicating that the objects on the recorded images meet the at least one defined criterion,
displaying the digital recorded images of the objects that are assigned to the second class to one or more users,
receiving information from the one or more users for each digital recorded image displayed, said information indicating whether the particular object meets the at least one defined criterion or does not meet the at least one defined criterion,
labelling the displayed digital image with a first identifier, wherein the recorded images of those objects for which the information indicates that the objects meet the at least one defined criterion are labelled with the first identifier, and the recorded images of those objects for which the information indicates that the objects do not meet the at least one defined criterion are labelled with a second identifier,
storing the labelled recorded images in a data memory and/or feeding the recorded images with the respective identifiers to a self-learning model for classifying objects as a training and/or validation dataset.

The embodiments of invention are explained in more detail below, without distinguishing between the invention objects (method, device, system, computer program product). The following explanations are intended instead to apply to all objects of the invention in an analogous manner, regardless of the context in which they are given (method, device, system, computer program product).

Whenever steps in a sequence are mentioned in the present description or in the claims, this does not necessarily mean that the invention is limited to the sequence mentioned. Rather, it is conceivable for the steps to be executed in a different order, or even in parallel with each other; unless a step builds on another step, which makes it mandatory that the dependent step is executed afterwards (which will be clear from the specific case). The sequences given thus represent preferred embodiments of the invention.

One of the aims of the present invention, according to some embodiments, is to create a training and/or validation dataset for a system for the automatic classification of objects based on a self-learning algorithm.

An object for the purposes of some embodiments of the present invention is a physical object. This can be a raw material, an intermediate product, a product, a waste product, a tool, an item of packaging or the like. The object can be an inanimate object, but it can also be a living object such as a plant. It is also possible that the object is a collection or a grouping of a plurality of individual objects. It is also conceivable that the object is only one component of a physical object.

In a first step, a plurality of objects are supplied to an automated classification.

The term classification or categorization refers to the allocation of objects to separate groups (classes).

In the classification according to some embodiments of the present invention, each object is assigned to exactly one of at least two classes. The number of classes is preferably in the range of two to ten, more preferably in the range of two to five, even more preferably in the range of two to four. In a particularly preferred embodiment, the number of classes is exactly two or three.

The classification is carried out automatically, i.e. without human intervention.

The classification is based on one or more features. The at least one feature of the object therefore determines the class in which the object is categorized. The at least one feature is an optical feature, i.e. it is determined by means of an optical sensor or a plurality of optical sensors.

A “sensor”, also referred to as a detector, (measurement variable or measurement) recorder or (measurement) sensor, is a technical component capable of capturing certain physical properties and/or the material composition of its environment, either qualitatively or quantitatively as a measurement variable. The respective measurement variable is acquired by means of a physical effect and transformed into a signal, usually an electrical signal, that can be further processed.

An optical sensor receives the electromagnetic radiation emitted and/or reflected and/or scattered by an object and/or that has passed through the object in a defined wavelength range and converts it into an electrical signal.

Thus, an optical sensor can be used to determine at least one optical feature of an object and the information relating to the optical feature can be made available for further processing.

The at least one optical feature characterizes the actual state of the object. The actual state is compared with a defined criterion, the target state. The classification of an object into one of the at least two classes is based on the result of the comparison. The objects for which the actual state meets the defined criterion, i.e. the actual state corresponds to the target state, are assigned to a first class. Those objects for which there is a defined probability that the actual state meets or does not meet the defined criterion are assigned to the second class. For the objects of the second class, there is therefore a defined probability that they will be assigned to the first class at a later time, or in other words, for the objects of the second class there is a specific degree of uncertainty as to whether or not they meet the defined criterion. Thus the objects assigned to the second class require a visual post-inspection by a human being. However, the visual post-inspection is not carried out based on the objects themselves (alone), but on digitally recorded images of the objects, as described below.

It is conceivable that in addition to the first and second classes, there is a third class, wherein the third class is assigned those objects for which the actual state does not (definitively) meet the defined criterion, i.e. the actual state does not (definitively) correspond to the target state.

In a further step, according to some embodiments, digital images of the objects are recorded. Typically, a digitally recorded image shows exactly one object or part of an object. It is conceivable that a plurality of digital images of an object may be captured.

The digital images can be captured before, during, or after automated classification. Digital images are usually recorded with a digital camera.

The recorded images of the objects allow a visual examination by a person as to whether or not the object meets the defined criterion; this means that the optical feature of the object in the digital image can be detected by a human being.

In a further step, according to some embodiments, the recorded images of the objects of the first class are labelled with a first identifier. The first identifier indicates that the objects on the images meet the at least one defined criterion.

Such an identifier is a piece of information that can be stored in a digital information storage device together with the digital image or as part of the digital image. For example, it is conceivable for the identifier to be an alphanumeric or binary or hexadecimal or other code, which is written into the header of the file containing the digital image, for example.

The recorded images that show the objects of the second class are submitted to one or more persons for visual inspection. Typically, the digital images are displayed to a person (also referred to as a user in this description) or to more than one person (multiple users) on a monitor. It is also possible for recorded images of the objects of the first class to be displayed to one or more persons for visual inspection.

The task assigned to the at least one person is to review the digital images and decide whether the object shown in the respective digital image meets the defined criterion or does not meet the defined criterion. The result of the respective decision is recorded in the form of an identifier. It is conceivable that in order to complete the task the at least one person will also visually examine the object shown in the respective digital image.

If the at least one person concludes that an object does meet the defined criterion, the digital image showing the respective object is labelled with the first identifier.

If the at least one person concludes that an object does not meet the defined criterion, the digital image showing the respective object is labelled with a second identifier.

The second identifier thus indicates that the object shown in the digital image does not meet the defined criterion.

The process of labelling a recorded image with the second identifier is the same as labelling a recorded image with the first identifier.

If images are presented to more than one person for visual inspection, the assessment results are combined. There are several possible options here: for example, it is conceivable that whenever a majority is of the opinion that the defined criterion is not met, the image will be labelled with the second identifier. It is also conceivable that even if only one person believes that the defined criterion is not met, the image is labelled with the second identifier. Another conceivable option is that whenever two people give a different assessment, the corresponding image is submitted to a third person for the final assessment. Other possibilities are conceivable.

It is also conceivable that the invention, according to some embodiments, is designed in such a way that objects that meet a first defined criterion are each labelled with a first identifier, and objects that meet a second defined criterion are each labelled with a second identifier. It is also possible that there are more than two labels and/or more than two defined criteria. Objects that do not meet any of the defined criteria are also marked with a corresponding identifier. The additional steps are then carried out in the same way as those described in this description.

The result of the identification of the recorded images is a set of so-called annotated digital images (labelled images). For each recorded image, information is available in a machine-processable form concerning whether the recorded image shows an object that meets a defined criterion or does not meet the defined criterion.

This set of annotated images can be stored in a data memory for further use.

This set of annotated images can also be used for training and/or validating a self-learning algorithm.

Other objects of the present invention, according to some embodiments, are thus a method, a device, a system and a computer program product for training and/or validating a self-learning algorithm for classifying objects.

A self-learning algorithm uses machine learning to generate a statistical model based on the training data. In other words, the examples are not merely learned by rote, but the algorithm “discovers” patterns and regularities in the training data. This allows the algorithm also to evaluate unknown data. Validation data can be used to check the quality of the evaluation of unknown data.

The self-learning algorithm is trained by means of supervised learning, i.e. the algorithm is presented with a sequence of recorded images and it is told which identifier the respective recorded image is labelled with. The algorithm then learns to create a relationship between the recorded images and the respective labels to predict an identifier for unknown images.

Self-learning algorithms trained by means of supervised learning are described in a range of publications from the prior art (see e.g. C. Perez: Machine Learning Techniques: Supervised Learning and Classification, Amazon Digital Services LLC—Kdp Print US, 2019, ISBN 1096996545, 9781096996545).

The self-learning algorithm is preferably an artificial neural network.

Such an artificial neural network comprises at least three layers of processing elements: a first layer with input neurons (nodes), an Nth layer with at least one output neuron (node), and N−2 hidden layers, where N is a natural number greater than 2.

The function of the input neurons is to receive digital images as input values. Normally, there is one input neuron for each pixel of a digital image. Additional input neurons may be provided for additional input values (e.g. conditions that existed when the respective recorded image was created, or additional information about the objects).

In such a network, the output neurons are used to predict a label for a digitally recorded image, indicating whether the object shown in the digital image meets or does not meet a defined criterion.

The processing elements of the layers between the input neurons and the output neurons are connected to each other in a predefined pattern with predefined connection weights.

The artificial neural network is preferably a so-called convolutional neural network (CNN).

A convolutional neural network is able to process input data in the form of a matrix. This allows digital images represented as a matrix (width×height×number of colour channels) to be used as input data. A standard neural network, e.g. in the form of a multi-layer perceptron (MLP), on the other hand, requires a vector as input, i.e. in order to use a recorded image as input, the pixels of the image would need to be unravelled into a long chain. This means, for example, that standard neural networks are not able to recognize objects in an image independently of the position of the object in the image. The same object at a different position in the image would have a completely different input vector.

A CNN consists essentially of filters (Convolutional Layer) and aggregation layers (Pooling Layer), which repeat alternately, and finally one or more layers of “standard”, fully connected neurons (Dense/Fully Connected Layer).

Details can be found in the prior art (see e.g.: S. Khan et al.: A Guide to Convolutional Neural Networks for computer Vision, Morgan & Claypool Publishers 2018, ISBN 1681730227, 9781681730226).

The neural network training can be carried out, for example, by means of a back propagation method. The aim is to achieve the most reliable mapping possible from given input vectors to given output vectors for the network. The quality of the mapping is described by an error function. The goal is to minimise the error function. The training of an artificial neural network in the back propagation procedure is carried out by modifying the connection weights.

In the trained state, the connection weights between the processing elements contain information regarding the relationship between the recorded images (input) and the label (output), which can be used to predict the label for a new recorded image.

A cross-validation method can be used to split the data into training and validation datasets. The training dataset is used in the back-propagation training of the network weights. The validation dataset is used to examine the predictive accuracy with which the trained network can be applied to unknown images.

The present invention, according to some embodiments, is preferably implemented by means of one or more computers. A “computer” is an electronic data processing device that processes data by means of programmable computational rules. The principle commonly used today, also known as the von Neumann architecture, defines five main components for a computer: the arithmetic unit (essentially the arithmetic-logic unit (ALU)), the control unit, the bus unit, the memory unit and the input/output unit(s). In modern computers, the ALU and the control unit have mostly been merged into one component, the so-called central processing unit (CPU).

In computer technology, a “peripheral” means any device connected to the computer that is used to control the computer and/or functions as an input and output device. Examples include the monitor (display screen), printer, scanner, mouse, keyboard, disk drives, camera, microphone, speakers, etc. In computer technology, internal connections and expansion cards are also considered to be peripherals.

Modern computers are often classified into desktop PCs, portable PCs, laptops, notebooks, netbooks and tablets, and so-called handhelds (such as smartphones); all of these systems can be used to implement the invention.

The inputs to the computer are made using input devices such as a keyboard, mouse, touch-sensitive screen (touchscreen), a microphone and/or the like. An input should also be understood as the selection of an entry from a virtual menu or a virtual list, or clicking on a selection box and the like.

The output is typically provided via a display, a printer, a speaker, and/or by storage in a data storage device.

The device according to some embodiments is preferably a computer which is configured by means of programmable computational rules to carry out the following steps:

receiving digital recorded images via an input unit, wherein each digital recorded image shows an object, the object shown being assigned to one of at least two classes, a first class containing objects that meet at least one defined criterion and a second class containing objects that are to undergo a visual inspection,
labelling the digital recorded images of the objects assigned to the first class with a first identifier by a control and calculation unit, the first identifier indicating that the objects on the recorded images meet the at least one defined criterion,
displaying the digital recorded images of the objects assigned to the second class to one or more users via an output unit,
receiving information from the one or more users via the input unit for each digital recorded image displayed, said information indicating whether the particular object meets the at least one defined criterion or does not meet the at least one defined criterion,
labelling the displayed digital image with an identifier by means of the control and calculation unit, wherein the images of the objects for which the information indicates that the objects meet the at least one defined criterion are labelled with the first identifier, and the images of those objects for which the information indicates that the objects do not meet the at least one defined criterion are labelled with a second identifier,
storing the labelled recorded images in a data memory and/or feeding the recorded images with the respective identifiers to a self-learning model for classifying objects as a training and/or validation dataset.

The invention, according to some embodiments, is explained in further detail in the following based on examples and drawings, without limiting the invention to the features and combinations of features used in the examples and shown in the drawings.

### BRIEF DESCRIPTION OF THE DRAWINGS

FIG. 1 shows an example of the device according to some embodiments in schematic form. The device (1) comprises a receiver unit (10), a control and calculation unit (20) and an output unit (30). The receiving unit (10) can be used to receive digital recorded images of objects. The control and calculation unit (20) is configured to display received images to a user of the device (1) via the output unit (30). In addition, the control and calculation unit (20) is configured to receive information for displayed images from the user via the input unit (10). In addition, the control and calculation unit (20) is configured to label recorded images with an identifier. The processing of the received images performed by the device (1) according to some embodiments is shown in FIG. 8.

FIG. 2 shows an example of the device according to some embodiments in schematic form. For the device (1) shown in FIG. 2, the same description applies as that provided for the device shown in FIG. 1. The device (1) also comprises a data memory (40) in which the labelled image files can be stored.

FIG. 3 shows an example of the device according to some embodiments in schematic form. For the device (1) shown in FIG. 3, the same description applies as that provided for the device shown in FIG. 1. The device (1) is connected to a separate data memory (40), in which the labelled image files can be stored.

FIG. 4 shows an example of the device according to some embodiments in schematic form. For the device (1) shown in FIG. 4, the same description applies as that provided for the device shown in FIG. 1. The control and calculation unit (20) of the device (1) comprises a self-learning algorithm (4) for classifying objects. The self-learning algorithm (4) can be trained with the labelled images in a supervised learning procedure and/or validated with the labelled images.

FIG. 5 shows a schematic representation of an example of the system according to some embodiments. The system S comprises a device (1) as shown in one of the FIG. 1, 2, 3 or 4, and a camera (2) for recording digital images of a plurality of objects.

FIG. 6 shows a schematic representation of a further example of the system according to some embodiments. The system S comprises a device (1) as shown in one of FIG. 1, 2, 3 or 4, a camera (2) for generating digital images of a plurality of objects, and a classification unit (3). The classification unit (3) is configured to perform an automatic classification of the objects based on at least one optical feature, wherein based on the at least one optical feature a test is automatically performed to determine whether the respective object meets at least one defined criterion or whether it should be subjected to a visual inspection.

FIG. 7 shows a schematic representation of a further example of the system according to some embodiments. The system S comprises a device (1) as shown in one of FIG. 1, 2, or 3, a camera (2) for generating digital images of a plurality of objects, and a classification unit (3). The classification unit (3) is configured to perform an automatic classification of the objects based on at least one optical feature, wherein based on the at least one optical feature a test is automatically performed to determine whether the respective object meets at least one defined criterion or whether it should be subjected to a visual inspection. The classification unit (3) comprises a self-learning algorithm (4) for classifying objects. The self-learning algorithm (4) can be trained and/or optimised with the labelled images in a supervised learning procedure and/or validated with the labelled images.

FIG. 8 shows an example of the processing of the images according to some embodiments in schematic form.

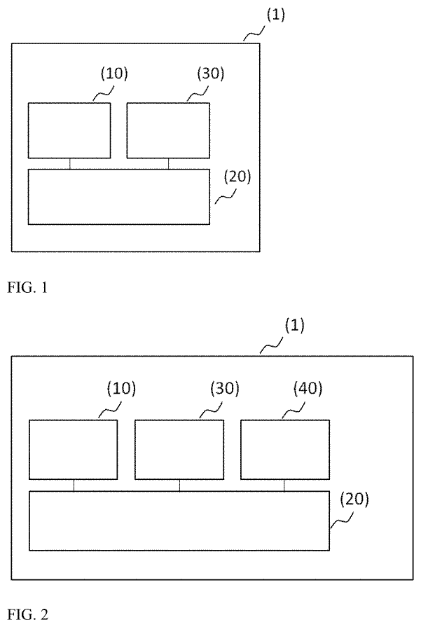

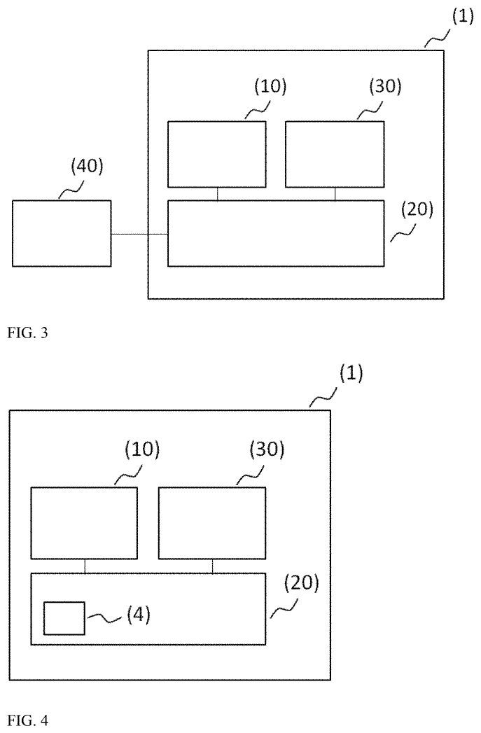

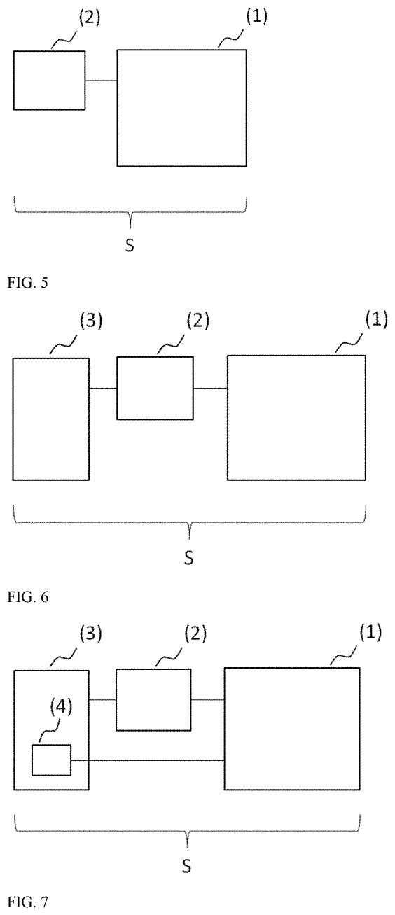

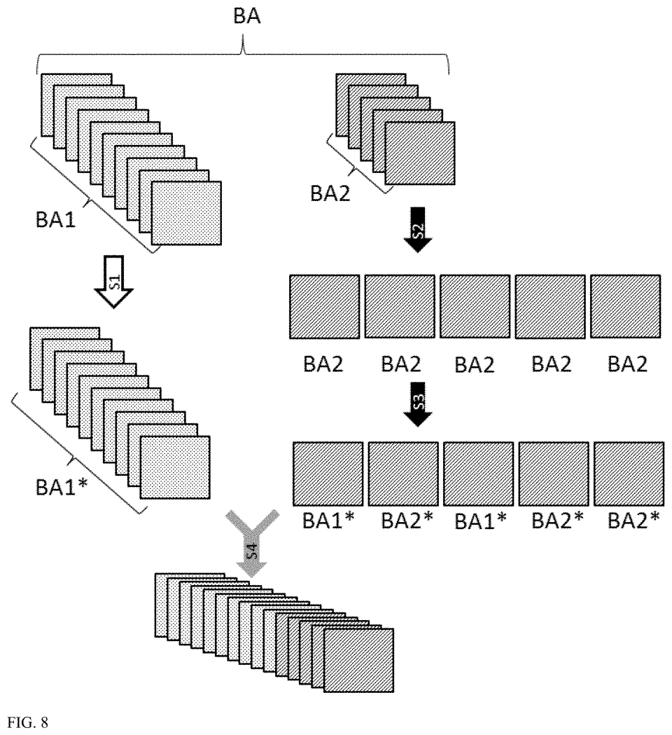

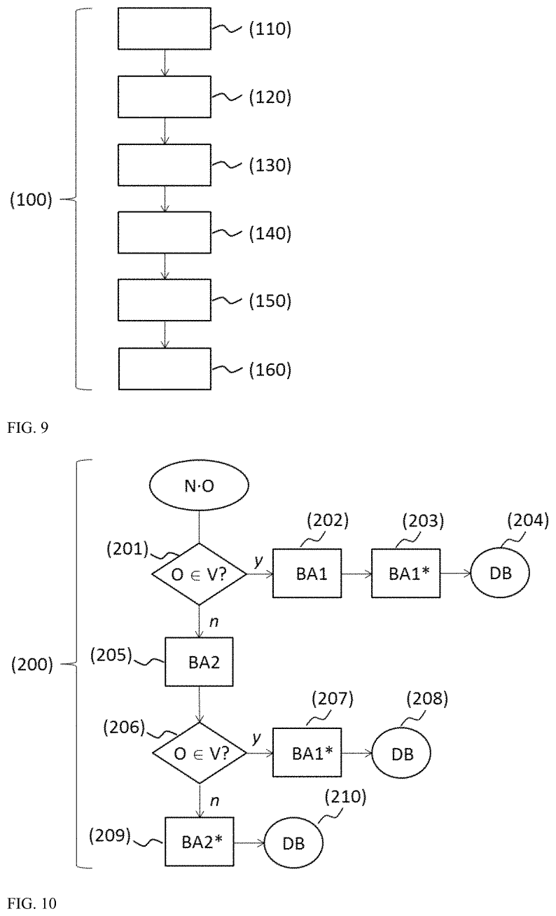

The recorded images BA can be divided into at least two groups. A first group of recorded images BA1 shows objects that meet a defined criterion. A second set of recorded images BA2 shows objects that are to be submitted to a visual inspection by a human being.

In step S1, the recorded images BA1 are labelled with a first identifier BA1*. The first identifier BA1* indicates that the object shown in the respective image meets a defined criterion.

The BA2 images are displayed to a user one at a time in step S2. In step 3, the user views the images, checking whether the objects shown in the images meet the defined criterion and labelling the images accordingly: the images showing objects for which the defined criterion is met are labelled with the first identifier BA1*; the images that show objects for which the defined criterion is not met are labelled with a second identifier BA2*. The second identifier BA2* thus indicates that the objects shown in the images (according to the visual inspection) do not meet the defined criterion.

In step S4, the labelled images are stored in a data memory.

Step S4 follows after steps S1 and S3. Step S3 is carried out after step S2. Step S1 can be carried out before step S2, in parallel with step S2, after step S2, in parallel with step S3 or after step S3.

FIG. 9 shows schematically in the form of a flow diagram an embodiment of the method according to some embodiments.

The method (100) comprises:

receiving digital recorded images, wherein each digital recorded image shows an object wherein the object shown is assigned to one of at least two classes, a first class containing objects that meet at least one defined criterion, and a second class containing objects that are to undergo a visual inspection,

labelling the digitally recorded images of the objects assigned to the first class with a first identifier, the first identifier indicating that the objects on the recorded images meet the at least one defined criterion,
displaying the digitally recorded images of the objects that are assigned to the second class to one or more users,
receiving information for each displayed digitally recorded image from the one or more users, said information indicating whether the particular object meets the at least one defined criterion or does not meet the at least one defined criterion,
labelling the displayed digital image with a first identifier, wherein the recorded image of the particular object for which the information indicates that the object meets the at least one defined criterion is labelled with the first identifier and the recorded images of the objects for which information indicates that the object does not meet the at least one defined criterion are labelled with a second identifier,
storing the labelled recorded images in a data memory and/or feeding the recorded images with the respective identifiers to a self-learning model for classifying objects as a training and/or validation dataset.

FIG. 10 shows a flowchart of an embodiment of the method according some embodiments. The starting point of the method is a number of N objects O (N·O). For each individual object, in step (201) it is automatically checked to determine whether the object meets a defined criterion (V) (OϵV?).

If the object meets the defined criterion (“y”), a digital image BA1 of the object is recorded in step (202) and this image is labelled with a first identifier BA1* in step (203). The recorded image thus labelled is stored in a data memory (DB) in step (204).

In the event that the object does not meet or does not clearly meet the defined criterion (“n”), a digital image BA2 of the object is recorded in step (205) and this recorded image is displayed to a user in step (206), so that in a visual inspection the user checks whether the object shown in the digital recorded image meets the defined criterion (V) (OϵV?). If the object meets the defined criterion (“y”), the recorded image is labelled with the first identifier (BA1*) in step (207) and the labelled image is stored in the data memory (DB) in step (208). If the object does not meet the defined criterion (“n”), the recorded image is labelled with a second identifier (BA2*) in step (209) and the labelled image is stored in the data memory (DB) in step (210).

The following text describes an application example for the present invention, according to some embodiments. The objects in this example are glass ampoules. These glass ampoules are to be checked to determine whether they are undamaged (i.e. do not contain cracks or fissures) and are clean. The defined criterion (target state) is therefore a clean, undamaged glass ampoule.

An optical method is used to check whether the individual glass ampoules are clean and undamaged. For this purpose, visible light from a source of electromagnetic radiation is directed through each glass ampoule from one side. An optical sensor on the opposite side measures the transmitted radiation. Fissures, scratches, cracks and/or impurities cause less radiation to be transmitted, as some of the radiation is absorbed and/or scattered in other directions by the fissures, scratches, cracks and/or impurities. The intensity of the transmitted radiation can therefore be used to check whether the respective glass ampoule is undamaged and clean.

The glass ampoules are measured one at a time. If the intensity of the transmitted radiation (optical feature) is above an empirically determined threshold, the respective glass ampoule is clean and undamaged. If the intensity is not above the threshold, the glass ampoule is likely to be dirty and/or damaged. For the glass ampoules that are likely to be dirty and/or damaged, a post-inspection by a human being should be carried out. The post-inspection is performed using digital images that are generated of the glass ampoules.

Digital images of all glass ampoules are recorded. The images of the glass ampoules that are clean and undamaged are labelled with a first identifier. The first identifier indicates that the glass ampoules in the images are clean and undamaged.

The recorded images of the glass ampoules that are likely to be dirty and/or not intact are displayed to a user on a monitor. The user indicates for each displayed image whether the glass ampoule currently displayed is clean and undamaged. If it is clean and undamaged, the recorded image is labelled with the first identifier. If it is not clean and/or undamaged, the recorded image is labelled with a second identifier. The second identifier indicates that the glass ampoule shown is not clean and/or not undamaged.

The labelled images are stored in a data memory and/or are fed to a self-learning algorithm for classifying glass ampoules as a training and/or validation dataset.

1: A method comprising:
creating digital images, wherein each digital recorded image shows an object, wherein the object shown is assigned to one of at least two classes, a first class containing objects that meet at least one defined criterion, and a second class containing objects that are to undergo a visual inspection,
labelling the digital recorded images of the objects assigned to the first class with a first identifier, the first identifier indicating that the objects on the recorded images meet the at least one defined criterion,
displaying the digital recorded images of the objects that are assigned to the second class to one or more users,
receiving information from the one or more users for each digital recorded image displayed, said information indicating whether the particular object meets the at least one defined criterion or does not meet the at least one defined criterion,
labelling the displayed digital image with a first identifier, wherein the recorded images of those objects for which the information indicates that the objects meet the at least one defined criterion are labelled with the first identifier, and the recorded images of those objects for which the information indicates that the objects do not meet the at least one defined criterion are labelled with a second identifier,
storing the labelled recorded images in a data memory and/or feeding the recorded images with the respective identifiers to a self-learning model for classifying objects as a training and/or validation dataset.

2: The method of claim 1, comprising:
classifying objects into at least two classes, the first class and the second class, wherein the first class contains those objects that meet at least one defined criterion and the second class contains those objects that are to be subjected to the visual inspection, wherein the classification is temporally upstream of at least the labelling the digital recorded images of the objects assigned to the first class with the first identifier, displaying the digital recorded images of the objects that are assigned to the second class to one or more users, receiving information from the one or more users for each digital recorded image displayed, labelling the displayed digital image, storing the labelled recorded images in a data memory and/or feeding the recorded images with the respective identifiers to the self-learning model for classifying objects as the training and/or validation dataset.

3: The method of claim 2, wherein the classification is carried out automatically on the basis of at least one optical feature, which is automatically acquired by one or more optical sensors.

4: The method of claim 2, wherein the method is executed in the following order:
Classifying objects into the at least two classes, the first class and the second class, wherein the first class contains those objects that meet the at least one defined criterion and the second class contains those objects that are to be subjected to the visual inspection,
Recording digital images, wherein each digital recorded image shows the object, wherein the object shown is assigned to one of the at least two classes, the first class containing objects that meet the at least one defined criterion, and the second class containing objects that are to undergo the visual inspection,
Labelling the digital recorded images of the objects assigned to the first class with the first identifier, the first identifier indicating that the objects on the recorded images meet the at least one defined criterion,
Displaying the digital recorded images of the objects that are assigned to the second class to the one or more users,
Receiving information from the one or more users for each digital recorded image displayed, said information indicating whether the particular object meets the at least one defined criterion or does not meet the at least one defined criterion,
Labelling the displayed digital image with the first identifier, wherein the recorded images of those objects for which the information indicates that the objects meet the at least one defined criterion are labelled with the first identifier, and the recorded images of those objects for which the information indicates that the objects do not meet the at least one defined criterion are labelled with the second identifier,
Storing the labelled recorded images in the data memory and/or feeding the recorded images with the respective identifiers to the self-learning model for classifying objects as the training and/or validation dataset.

5: The method of claim 2, wherein the method is executed in the following order:
Recording digital images, wherein each digital recorded image shows the object, wherein the object shown is assigned to one of the at least two classes, the first class containing objects that meet the at least one defined criterion, and the second class containing objects that are to undergo the visual inspection,
Classifying the objects into the at least two classes, the first class and the second class, wherein the first class contains those objects that meet the at least one defined criterion and the second class contains those objects that are to be subjected to the visual inspection,
Labelling the digitally recorded images of the objects assigned to the first class with the first identifier, the first identifier indicating that the objects on the recorded images meet the at least one defined criterion,
Displaying the digital recorded images of the objects that are assigned to the second class to the one or more users,
Receiving information from the one or more users for each digital recorded image displayed, said information indicating whether the particular object meets the at least one defined criterion or does not meet the at least one defined criterion,
Labelling the displayed digital image with the first identifier, wherein the recorded images of those objects for which the information indicates that the objects meet the at least one defined criterion are labelled with the first identifier, and the recorded images of those objects for which the information indicates that the objects do not meet the at least one defined criterion are labelled with the second identifier,
Storing the labelled recorded images in the data memory and/or feeding the recorded images with the respective identifiers to the self-learning model for classifying objects as the training and/or validation dataset.

6: The method of claim 2, wherein at least two of the following are executed in parallel:
recording digital images, wherein each digitally recorded image shows the object, wherein the object shown is assigned to one of the at least two classes, the first class containing objects that meet the at least one defined criterion, and the second class containing objects that are to undergo the visual inspection,
classifying the objects into the at least two classes, the first class and the second class, wherein the first class contains those objects that meet the at least one defined criterion and the second class contains those objects that are to be subjected to the visual inspection,
labelling the digitally recorded images of the objects assigned to the first class with the first identifier, the first identifier indicating that the objects on the recorded images meet the at least one defined criterion,

7: The method of claim 1, wherein the self-learning model is or comprises an artificial neural network—preferably a Convolutional Neural Network.

8: A device comprising:
a receiving unit,
a control and calculation unit and
an output unit,
wherein the control and calculation unit is configured to cause the receiving unit to receive digital recorded images, wherein each digital recorded image shows an object, the object shown being assigned to one of at least two classes, a first class containing objects that meet at least one defined criterion and a second class containing objects that are to undergo a visual inspection,
wherein the control and calculation unit is configured to label the digitally recorded images of the objects of the first class with a first identifier, the first identifier indicating that the objects on the recorded images meet the at least one defined criterion,
wherein the control and calculation unit is configured to cause the output unit to display the recorded images of the objects of the second class to a user,
wherein the control and calculation unit is configured to cause the receiving unit to receive information from the user relating to displayed recorded images, the information indicating whether the respective object meets the at least one defined criterion or does not meet the at least one defined criterion,
wherein the control and calculation unit is configured, based on the information received, to label the respectively displayed recorded image with the first identifier, wherein the recorded image of the object for which the information indicates that the object meets the at least one defined criterion is labelled with the first identifier, and the recorded image of the object for which the information indicates that the object does not meet the at least one defined criterion is labelled with a second identifier,
wherein the control and calculation unit is configured to store the labelled images in a data memory and/or to supply them to a self-learning object classification model as a training and/or validation dataset.

9: The device of claim 8, wherein the self-learning model is or comprises an artificial neural network—preferably a Convolutional Neural Network.

10: A system comprising:
a camera for generating digital recorded images of objects; and
a device comprising:
a receiving unit;
a control and calculation unit; and
an output unit;
wherein the control and calculation unit is configured to cause the receiving unit to receive digital recorded images, wherein each digital recorded image shows an object, the object shown being assigned to one of at least two classes, a first class containing objects that meet at least one defined criterion and a second class containing objects that are to undergo a visual inspection,
wherein the control and calculation unit is configured to label the digitally recorded images of the objects of the first class with a first identifier, the first identifier indicating that the objects on the recorded images meet the at least one defined criterion,
wherein the control and calculation unit is configured to cause the output unit to display the recorded images of the objects of the second class to a user,
wherein the control and calculation unit is configured to cause the receiving unit to receive information from the user relating to displayed recorded images, the information indicating whether the respective object meets the at least one defined criterion or does not meet the at least one defined criterion,
wherein the control and calculation unit is configured, based on the information received, to label the respectively displayed recorded image with the first identifier, wherein the recorded image of the object for which the information indicates that the object meets the at least one defined criterion is labelled with the first identifier, and the recorded image of the object for which the information indicates that the object does not meet the at least one defined criterion is labelled with a second identifier,
wherein the control and calculation unit is configured to store the labelled images in a data memory and/or to supply them to a self-learning object classification model as a training and/or validation dataset.

11: A non-transitory computer readable medium storing a computer program comprising instructions, the computer program can be loaded into a working memory of a computer, which when executed by the computer, causes the computer to:
receive digital recorded images, wherein each digital recorded image shows an object wherein the object shown is assigned to one of at least two classes, a first class containing objects that meet at least one defined criterion, and a second class containing objects that are to undergo a visual inspection,
label the digital recorded images of the objects assigned to the first class with a first identifier, the first identifier indicating that the objects on the recorded images meet the at least one defined criterion,
display the digital recorded images of the objects that are assigned to the second class to one or more users,
receive information from the one or more users for each digital recorded image displayed, said information indicating whether the particular object meets the at least one defined criterion or does not meet the at least one defined criterion,
label the displayed digital image with an identifier, wherein the recorded images of those objects for which the information indicates that the objects meet the at least one defined criterion are labelled with the first identifier, and the recorded images of those objects for which the information indicates that the objects do not meet the at least one defined criterion are labelled with a second identifier,
store the labelled recorded images in a data memory and/or feeding the recorded images with the respective identifiers to a self-learning model for classifying objects as a training and/or validation dataset.

12. (canceled)
